(19) United States
(12) Patent Application Publication
(10) Pub. No.: US 2015/0273985 A1
(43) Pub. Date: Oct. 1, 2015

(54) Cabin Air Filter Element

(71) Applicant: MANN+HUMMEL GMBH, Ludwigsburg (DE)

(72) Inventors: Oliver Luley, Speyer (DE); Ina Unger, Hemmingen (DE)

(21) Appl. No.: 14/668,191

(22) Filed: Mar. 25, 2015

(30) Foreign Application Priority Data
Mar. 25, 2014 (DE) 10 2014 004 220.0

(51) Int. Cl. B60H 3/06; B01D 46/00; B01D 53/04

(52) U.S. Cl. CPC B60H 3/0658; B01D 53/04; B01D 46/0023; B60H 2003/0691

(57) ABSTRACT

A cabin air filter element for a cabin air filter for the driver's cabin of agricultural and work machines is provided with a filter element frame and filter layers including a prefilter layer, an adsorption filter layer, and a fine filter layer. The filter layers are flowed through in a flow direction. A circumferentially extending gasket is arranged on the filter element frame for separation of the raw side from the clean side in a mounted state of the cabin air filter element. The filter element frame has a first area and a second area, wherein the first area has a first effective cross-sectional area perpendicular to the flow direction and the second area has a second effective cross-sectional area perpendicular to the flow direction. The second effective cross-sectional area has a size that amounts to only a portion of a size of the first effective cross-sectional area.

### BACKGROUND OF THE INVENTION

The invention concerns a cabin air filter element for a cabin air filter for air that is supplied to a driver's cabin in vehicles, agricultural machines, construction machines, and work machines.

Nowadays, contaminants are removed as completely as possible from the air that is flowing into a vehicle cabin. Possibly occurring contaminants are, for example, respirable dust, pollen, carbon-particulate matter or aerosols. Filtration of such contaminants is important in particular in case of applications in which high concentrations of pesticides or liquid fertilizer occur in the ambient air when spraying devices for these substances are used. For this purpose, various filter means are available. For example, particle filters, activated carbon filters, and HEPA filters are regularly used. They are combined in different layers and different arrangements in order to achieve the desired filtration action for the cabin air.

The increasingly intensive integration of different components in the field of machines and the desire for longer filter service lives cause conflicts in the targeted goals for the arrangement and the construction of cabin air filters. For a high integration, a very compact configuration and a filter volume as small as possible are advantageous. Longer service life, on the other hand, requires in general larger filter volumes.

### SUMMARY OF THE INVENTION

It is an object of the invention to provide a cabin air filter element for a cabin air filter that provides the desired filtration action for dusts, aerosols, and gases, has a sufficiently long service life, and at the same time provides for a particularly good integration capability.

This object is solved by a cabin air filter element for a cabin air filter for the driver's cabin of agricultural and work machines, wherein the cabin air filter element comprises a filter element frame, a prefilter layer, an adsorption filter layer, a fine filter layer, in particular for separation of aerosols, wherein the filter layers substantially are flowed through along a flow direction, and wherein the filter element frame comprises a first area with a first effective cross-sectional area perpendicular to the flow direction, and a second area with a second effective cross-sectional area perpendicular to the flow direction, wherein the second effective cross-sectional area amounts to only a portion of the first effective cross-sectional area, and wherein a circumferentially extending gasket for separation of the raw side from the clean side in the mounted state is provided.

Further embodiments of the invention are disclosed in the dependent claims.

The cabin air filter element according to the invention is an exchangeable filter element for a cabin air filter for a driver's cabin of agricultural and work machines, in particular with spraying or atomizing devices for pesticides or fertilizers and can be installed in a filter housing which is fast with the vehicle. The cabin air filter element comprises a prefilter layer, an adsorption filter layer, a fine filter layer in particular for separation of aerosols, as well as a filter element frame. The filter element frame defines by its geometry a flow direction along which the taken-in air flows through the aforementioned filter layers.

According to the invention, it is provided that the filter element frame comprises two areas. In the first area of the filter element frame, a first effective cross-sectional area with regard to flow through of the taken-in air through the filter layers is provided. In the second area, a corresponding second effective cross-sectional area is provided. Effective cross-sectional area is to be understood in this context as the size of a surface which is arranged perpendicular to the flow direction and is available for the flowing air for flow through of the respective filter layer. Moreover, a circumferentially extending gasket is provided. The circumferentially extending gasket serves for separation of the raw side of the cabin air filter element from the clean side when the cabin air filter element is installed in the filter housing of the cabin air filter. The first area is preferably arranged geometrically upstream relative to the gasket, the second area is preferably arranged geometrically downstream relative to the gasket. The second effective cross-sectional area amounts to only a fraction of the first effective cross-sectional area. Accordingly, the filter layer(s) arranged in the second area has/have a smaller effective cross-sectional area available. Thus, a cross-sectional step between the first and the second area is formed. This has in general the result that the circumference of the filter element frame in the second area is smaller than in the first area. Preferably, the circumference of the second area, viewed in the flow direction, is in particular completely arranged within the circumference of the first area. With this downstream arrangement of a second area downstream of the gasket plane, it is possible to develop constructive spaces which otherwise would not be utilized or available. Even though the cross-sectional reduction according to the invention is generally not desirable because it causes a greater height of the corresponding filter section, this measure according to the invention enables, on the other hand, the constructive development of the flow space located downstream of the gasket plane for filter media and to achieve in this way a higher integration and simultaneously an increased filter volume.

An exemplary embodiment of the invention provides that in the first area the prefilter layer and the adsorption filter layer are arranged. In the second area, the fine filter layer is arranged. Alternatively, it can be provided that the first area houses the prefilter layer, the fine filter layer, and a first adsorption filter layer. A second adsorption filter layer is arranged in the second area. The division of the adsorption filter into two separate layers and the arrangement of the second layer in an area which is downstream of the gasket plane of the cabin air filter element provides a constructive alternative in case that a certain sequence of the filter layers is desired. The division of the adsorption filter medium is required generally because the adsorption filter medium has the greatest volume compared to the prefilter and fine filter media.

The prefilter layer can be embodied in an embodiment according to the invention as a particle filter layer, for example, as a flat filter or as a prefilter foam. In one embodiment, an unfolded or zigzag-shaped folded filter medium can be employed as a prefilter layer. It can be comprised, for example, of cellulose, plastic foam or nonwoven or can comprise a single-layer or multi-layer combination of layers of such filter media.

A plastic foam filter medium layer for the prefilter layer can be comprised, for example, of a reticulated foam, in particular polyurethane foam, for example, on the basis of polyether or polyester, or can comprise one or several layers of this foam. The weight per volume of such foams can be in the range of 20-70 kg per m³.

As cellulose filter medium for the prefilter layer, for example, a cellulose filter medium with epoxide impregnation can be employed. Preferably, the cellulose filter medium has a weight per surface area of 80-140 g/m², preferably 100-120 g/m². In a preferred embodiment, the medium has a maximum pore size in the range of 30-40 μm and/or an air permeability of approximately 100-400 l/m²s, preferably between 200 and 300 l/m²s, measured, respectively, at a pressure differential of 200 Pa (measured here and in the following preferably according to DIN EN ISO 9237). In this way, the downstream layers can be protected from dust deposits and their function can therefore be ensured. In an embodiment, the impregnation contents, i.e., the weight proportion of the impregnation agent relative to the weight per surface area of the filter medium is between 15 and 30%.

As a nonwoven filter medium for the prefilter layer, preferably a combination of a spunbonded nonwoven layer and a melt-blown layer (nonwoven of melt-blown plastic fibers) can be employed. Both layers can be produced in each case of polyamide (PA), polyester (PES) or polypropylene (PP). The nonwoven filter medium has preferably a weight per surface area between 60 and 140 g/m², preferably between 80 and 120 g/m², and/or a thickness in the range of 0.5-1 mm, especially preferred of 0.5-0.8 mm. Further preferred, the air permeability is in the range of 1,000-2,000 l/m²s, particularly preferred between 1,200 and 1,800 l/m²s, at a pressure differential of 200 Pa.

In one embodiment, the prefilter layer, in particular according to ISO 5011, has a separation degree of 99% for test dust PTI fine, in particular according to ISO 14269-4.

The prefilter layer has in a preferred embodiment a weight per surface area of 75-125 g/m². Preferably, the filter medium of the prefilter layer has an air permeability of 100-200 l/m²s at a pressure differential of 200 Pa.

By using the prefilter layer, it can be achieved that the adsorption layer and the fine filter layer are protected from too much dust loading. Accordingly, their function (gas separation of the adsorption layer and aerosol separation of the fine filter layer) is impaired to a degree as minimal as possible even for intake air that is greatly loaded with dust.

The adsorption filter layer can comprise activated carbon, for example, as an activated carbon bellows, as filter medium.

The employed activated carbon can be obtained, for example, from wood or coal, can be polymer-based, tar-based or coconut husk-based. In a preferred embodiment, as a starting material for the activated carbon, ion exchange spheres are used which are produced from polymers, for example, synthetic resins, in particular from divinyl benzene-crosslinked polystyrene.

In one embodiment, a hydrophobic activated carbon is employed as activated carbon. Hydrophobic activated carbons are understood in particular to be those that have a comparatively minimal water adsorption capacity. Preferably, an activated carbon is employed which, at a relative air humidity of 50%, has a water adsorption of <10% by weight, in particular relative to the adsorption branch of the isothermal curve. This water adsorption is particularly preferred <5% by weight.

In one embodiment, the activated carbon has a BET surface area of greater than 400 m²/g, advantageously greater than 600 m²/g, preferably greater than 800 m²/g, particularly preferred greater than 1,000 m²/g (preferably determined according to DIN ISO 9277:2003-05). In this way, even in small spaces a satisfactory adsorption can be ensured.

In one embodiment, the activated carbon is provided in pourable or free-flowable form, for example, in the form of particles that are grain-shaped or spherical or shaped otherwise. The activated carbon particles comprise preferably activated carbon particle sizes (average diameter) between 0.1 and 1 mm, preferably 0.2 to 0.7 mm, and can be present, for example, in the form of a granular activated carbon or spherical activated carbon.

For the adsorption filter layer, for example, an open pore foam with free-flowable activated carbon can be employed. In this context, for example, reticulated foams, for example, of plastic materials such as polyurethane, polyurethane ether, or polyurethane ester, can be employed. Preferably, the pore sizes of the foam are between 20 and 50 ppi (pores per inch) or between 0.5 and 2 pores per millimeter. Measurement is done by a comparative optical method, wherein under the microscope a completely formed pore is defined as a “standard pore” and, across a stretch, the pores present therein are compared with the standard pore and counted. Pores which in comparison to the standard pore are not completely formed are counted proportionally. In this foam, preferably activated carbon particles are introduced and preferably fastened. The activated carbon particles are preferably fixed within the foam by an adhesive, for example, by means of a two-component adhesive on the basis of polyurethane. This can be achieved, for example, in that the foam is impregnated first with an adhesive and subsequently, before the adhesive dries or hardens, activated carbon particles are poured in, for example, with shaking. In this context, a two component adhesive, a melt adhesive or an aqueous adhesive can be employed.

In one embodiment, as an adsorption filter layer, a layer of a fixed filling with activated carbon is used. This can be realized in a single-layer or multi-layer configuration. A fixed filling is to be understood as an arrangement in which a carrier layer is provided and on the latter a bulk material layer of activated carbon particles is fastened. As a carrier layer, for example, an expanded plastic grid or a layer of a flat material, for example, of a particle filter medium, can be used. In a preferred embodiment, as a carrier layer a nonwoven of spunbonded or meltblown polyester fibers, for example, PET fibers (polyethylene terephthalate) or PBT fibers (polybutylene terephthalate) can be employed. It can have a weight per surface area of 25-120 g/m², preferably 50-100 g/m², particularly preferred 65-85 g/m², and an air permeability >3,000 l/m²s, preferably >5,000 l/m²s, at a pressure differential of 200 Pa. The air permeability is measured in particular according to ISO 9347. The bulk material layer of activated carbon particles is applied onto the carrier layer and preferably fastened on the carrier layer by a fine adhesive application. This is done, for example, in the form of a plurality of adhesive dots applied onto the carrier layer or by means of a net of adhesive filaments that is applied between the carrier layer and the bulk material layer and/or between the bulk material layer during pouring and/or onto the bulk material layer. The bulk material layer comprises preferably a fill of 100-1,200 g/m² of activated carbon particles on the carrier layer. Preferably, between 800 and 1,000 g/m² are employed. The layer of a fixed filling comprising carrier layer and bulk material layer has preferably an air permeability in the range of 800 to 1,200 l/m²s, in particular between 900 and 1,100 l/m²s, and a weight per surface area in the range of 850 to 1,250 g/m², in particular between 950 and 1,150 g/m², for a layer thickness in particular in the range of 2 to 6 mm.

In this way, a stable layer of the fixed filling that is easy to process and provides high performance is provided which can be combined by machine processing to a multi-layer semi-finished product.

In one embodiment, an unfolded or zigzag-shaped folded layer configuration of a carrier layer, a cover layer, and free-flowable activated carbon that is introduced in between is used as an adsorption filter layer. In this way, a semi-finished product with a carrier layer and a cover layer, respectively, and an intermediately arranged bulk material layer is formed. Several of such semi-finished products can in turn be arranged on top of each other for increasing the filtration performance, for example, between two and 20 semi-finished products, preferably between and 15 semi-finished products.

The cover layer can be directly applied onto the bulk material layer and, for example, can comprise a plastic grid or a layer of a flat material, for example, a particle filter medium, or can be comprised thereof. In a preferred embodiment, as a cover layer a nonwoven of spunbonded or meltblown polyester fibers is employed. It can have a weight per surface area of 25-150 g/m², preferably 50-100 g/m², particularly preferred 65-85 g/m², and an air permeability >3,000 l/m²s, preferably >5,000 l/m²s.

In one embodiment, the adsorption filter layer comprises a layer configuration of several fixed fillings. For example, a first layer of a fixed filling can be laid with its side on which the activated carbon is arranged (activated carbon side) onto the activated carbon side of a second layer of a fixed filling and connected therewith, for example, by an adhesive connection. In this way, a semi-finished product with two carrier or cover layers and intermediately arranged bulk material layer can be formed. Several of such semi-finished products can be arranged on top of each other for increasing the filtration performance, for example, between two and 10 semi-finished products, preferably between 3 and 7 semi-finished products. Alternatively or in combination, arrangements are also conceivable in which the carrier layer of a layer of a fixed filling is laid onto the activated carbon layer of another fixed filling. This arrangement can then be terminated by a turned-over layer with fixed filling or a cover layer. For example, between 4 and 20 layers of a fixed filling can be arranged on top of each other.

In one embodiment, the entire adsorption filter layer can form a zigzag-shaped folded layered configuration or comprise individual, stacked, separately folded or unfolded layers of semi-finished product or layers of fixed fillings.

Preferably, by means of the illustrated variants, several adsorption filter layers in layered configuration, comprising on top of each other a carrier layer, a cover layer, and free-flowable activated carbon introduced in between, can form a complete adsorption filter layer. In this context, in particular between 2 and 30, preferably between 5 and 15, layers of semi-finished product or of fixed filling are arranged on top of each other for formation of the complete adsorption filter layer and optionally connected with each other by means of a connecting means, for example, a lateral band of nonwoven or textile material, in a seal-tight way to a partial adsorption filter. In this context, the lateral band can be attached by means of an adhesive to the layers. As an alternative to the lateral band, in particular a glued-on, injection-molded or fused plastic frame or a potting compound, in particular polyurethane, cast on by means of a casting mold onto the layers, can be used for lateral sealing.

In one embodiment, the adsorption filter layer has two areas with different activated carbon density. In this context, preferably an area with higher activated carbon density is arranged at the outflow side and an area with reduced activated carbon density is arranged at the inflow side. This can be achieved, for example, in that two layers of foams filled differently with activated carbon particles are placed on top of each other wherein the layer at the outflow side has a higher degree of filling with activated carbon than the layer at the inflow side. Alternatively, as described above in various variants, a layer configuration of layers with fixed fillings of activated carbon particles can be employed in which one or several layers at the outflow side or layers that in particular terminate the layer configuration relative to the outflow side can have a higher activated carbon density. This can be achieved, for example, in that in case of the same materials for carrier layers, bulk material layers, and cover layers, the layers at the outflow side are calendered in particular before, during or after hardening of the adhesive in such a way that the layer thickness is reduced and, in this way, the activated carbon density is increased. However, it is also possible to employ for the layer(s) with higher activated carbon density an activated carbon granular material which has a higher bulk density than that used for the layers with reduced density. This can be realized either by activated carbons with different specific density or by different geometries of the particles. In this way, in particular a blocking layer is realized which can reliably enable the separation of residual concentrations of harmful gases. In this way, additional safety for the user can be provided.

In a preferred embodiment, the adsorption filter layer comprises an area at the outflow side comprising one or several in particular calendered layers of fixed fillings. This/these layer(s) have preferably an overlay of activated carbon of 100-1,200 g/m² of activated carbon particles on the carrier layer. Preferably, between 800 and 1,000 g/m² are used. The layer of a fixed filling comprising carrier layer and bulk material layer has for this purpose preferably an air permeability in the range of 800-1,200 l/m²s, in particular between 900 and 1,100 l/m²s, and a weight per surface area in the range of 850 to 1,250 g/m², in particular between 950 and 1,150 g/m², for a layer thickness in particular in the range of 1 to 3 mm. Particularly preferred, these layers or this layer has in the area at the outflow side with higher activated carbon density substantially the same overlay of activated carbon particles with regard to the weight per surface area and/or the type of activated carbon particles as the preceding layers at the inflow side with reduced activated carbon density. Further preferred, this layer or these layers have a significantly reduced layer thickness compared to the preceding layers at the inflow side with reduced activated carbon density. The layer thickness can be, for example, smaller than ⅔ of the thickness of the preceding layers at the inflow side with reduced activated carbon density, preferably between 40% and 60% of the thickness of the preceding layers at the inflow side. For this purpose, for example, the layer or the layers with higher activated carbon density are compacted by a calendering step or a similar process in such a way that such a thickness reduction is achieved compared to the unprocessed layer. In this way, the different areas with different activated carbon density can be produced from the same basic materials wherein only an additional calendering step is required for producing the layers with higher activated carbon density.

In a preferred embodiment, for the layer or the layers with higher activated carbon density, a filling of activated carbon particles is used which comprises a higher bulk density in comparison to the preceding layers at the inflow side with reduced activated carbon density. Preferably, the bulk density is higher by 50%, particularly preferably by 100%, in comparison to the layers at the inflow side with reduced activated carbon density.

In a particularly preferred embodiment, for the layer or the layers with higher activated carbon density a filling of activated carbon particles is employed which, in comparison to the preceding layers at the inflow side with reduced activated carbon density, comprises a reduced average particle diameter, in particular an average particle diameter reduced by at least 50%, preferably an average particle diameter reduced by at least 65%.

In one embodiment, the layers at the inflow side with reduced activated carbon density comprise activated carbon particles with a particle diameter in the range of 0.7 to 1.2 mm.

In one embodiment, the layer or the layers with higher activated carbon density have a filling of activated carbon particles with particle diameters in the range of 0.3 to 0.7 mm.

With the described embodiments of the adsorption filter stage, in particular a uniform distribution of the activated carbon is achieved which is ensured also during operation, for example, under vibration loading. In this way, a contribution is made to providing a reliable filter element.

With a filter medium according to the invention for an adsorption filter layer, in particular a cabin air filter element with an adsorption filter layer can be provided which in particular can be processed well. In particular, a cabin air filter element can be provided that at the outflow side has a test gas concentration below 10 μg/g according to the cyclohexane method in accordance with EN 12941:1998 for a test period of 70 min. measured according to EN 15695-2: 2009.

The fine filter layer can be designed as a HEPA bellows. In one embodiment, an unfolded or zigzag-shaped folded filter medium with glass fibers in a glass fiber layer is used as a fine filter layer. In this context, for example, a glass fiber nonwoven or glass fiber paper can be employed. It has preferably a one-sided or two-sided laminated cover layer of a spunbonded nonwoven. In this way, in particular a mechanical protection of the often very sensitive glass fiber medium is achieved. This is in particular advantageous when the glass fiber layer is folded because in this way in particular the medium can be protected from damage upon folding which can lead to local leaks or to cracks. Moreover, such cover layers can serve for improving the mechanical strength of the fine filter layer.

In one embodiment of the fine filter layer, the glass fibers have a fiber diameter in the range of 800 nm to 5 μm. Preferably, 90% of the fibers have a fiber diameter with in this range. Preferably, fibers are present with fiber diameters substantially within the entire fiber diameter range. Preferably, the average fiber diameter is within the aforementioned range. The fiber diameter can be, for example, measured according to the methods disclosed in DE 10 2009 043 273 A1 or US 2011/0235867 A1. Preferably, the filter medium of the fine filter layer has a weight per surface area between 60 and 100 g/m², particular preferred between 75 and 90 g/m². The glass fiber layer has preferably a thickness of 0.2-1 mm, especially preferred of 0.3-0.6 mm. Particularly preferred, a glass fiber layer is used which at an inflow rate of 7.5 cm/s has a resistance in the range of 300-600 Pa, preferably between 400 and 500 Pa. The air permeability is preferably in the range of 25 to 45 l/m²s at a pressure loss of 200 Pa. The pressure loss for a flow rate of 5.3 cm/s is preferably in the range of 200-700 Pa, particularly preferred between 450 and 600 Pa, or alternatively between 270-480 Pa. The pore size can be preferably in the range between 5 and 12 μm, particularly preferred between 8 and 10 μm.

In one embodiment, the spunbonded nonwovens of the cover layer(s) in particular are made of a polyester or polypropylene or polyamide as a material.

In one embodiment, the spunbonded nonwovens of the cover layer(s) have weights per surface area in the range of 10 and 250 g/m², preferably 20 to 60 g/m², and particularly preferred 30-34 g/m². Preferred layer thicknesses for the cover layers are in the range of 0.1 to 0.3 mm.

In one embodiment, the spunbonded nonwoven of the cover layers is formed of endless fibers which by means of heated air and/or galettes are stretched and randomly placed onto a transport belt. In the following, optionally a calendering process can be performed for generating a fiber composite and/or for affecting the nonwoven surfaces.

Instead of glass fibers, also plastic fibers can be employed as the fine filter layer. In one embodiment, such a synthetic HEPA medium is used in place of the described glass fiber medium. In this context, as a material, for example, polyester or polypropylene or polyamide can be employed; the fiber layers are preferably embodied in this context in nonwoven form and, for example, produced by the electro-spinning method, by the meltblown method or in other ways. Preferably, in this context an electret medium is used. As a result of the material properties of synthetic filter media, cover and protective layers are advantageously not needed. Preferably, a layer of meltblown nonwoven of polyester with a weight per surface area of, for example, 80-160 g/m², preferably between 80 and 120 g/m², and a thickness of, for example, approximately 0.4 to 1 mm is used. It is furthermore preferably applied onto a carrier layer. As a carrier layer, for example, a plastic support grid or a spunbonded nonwoven layer is conceivable. The further properties can correspond to those of the described fine filter layers with glass fibers.

In one embodiment, the prefilter layer and the fine filter layer are integrated in a filter bellows with layers of a prefilter medium and a fine filter medium that are in particular immediately resting on each other.

In one embodiment, a cover layer is laminated only at one side onto the glass fiber layer; the prefilter medium is directly laminated onto the other side. This layer combination can be integrated either flat into the cabin air filter element or can be folded as a complete layer combination in a zigzag shape and form a filter bellows. In this way, a cabin air filter element with several filter stages can be provided with minimal assembly expenditure and within a small space.

Cover layers and/or prefilter layers can be applied in various ways onto the glass fiber layer. In this context, for example, sprayed adhesives, for example in aqueous suspension, for example, on PU basis, can be used. Alternatively, melt adhesives that are sprayed on, applied by powder application or spread on, for example, in the form of adhesive nonwovens or grids between the layers, can be used, which, during calendering, melt and subsequently harden in a fixation step and, in this way, produce a permanent connection. In this way, in particular a secure connection between glass fiber layer and cover layers can be produced that enables folding of the filter medium.

With a filter medium according to the invention for a fine filter layer, in particular a cabin air filter element with a fine filter layer can be provided which in particular can be processed well to a folded bellows. In particular, a cabin air filter element can be provided that achieves an aerosol penetration of 0.05% measured according to EN 15695-2: 2009.

In the filter element according to the invention, prefilter layer and/or the adsorption filter layer and/or the fine filter layer can each form a separate partial filter element or can be connected to each other completely or partially in sequentially arranged layers.

In a preferred embodiment, the partial filter elements prefilter layer, adsorption filter layer, and fine filter layer comprise preferably each a lateral band that is circumferentially extending at the narrow sides, which is connected with the respective partial filter layer seal-tightly. The lateral band can be a textile or a nonwoven lateral band.

Narrow sides in this context preferably refer to the sides of the filter layer that are not flowed through. In this context, the narrow sides frame the inflow and outflow sides or surfaces. In a media configuration that is formed by zigzag-shaped folds of a medium, the term narrow sides encompasses thus the surfaces (end faces) that are formed by the zigzag-shaped course of two edges of the medium as well as the end faces which extend parallel to the fold edges.

In one embodiment, the prefilter layer and/or the adsorption filter layer and/or the fine filter layer are directly lying on each other and are folded as a unit in a zigzag shape.

In one embodiment, the partial filter elements for forming the cabin air filter element are in particular immediately placed on each other and are seal-tightly connected to each other by means of a frame, in particular by means of a lateral band circumferentially extending on the common narrow side, in particular of nonwoven or textile material which can be fused or glued to the partial filter elements.

Alternatively, a plastic frame that is in particular injection-molded can be provided. It can be either pre-manufactured and receive the partial filter elements which are glued or fused within the frame. Alternatively, the frame can be formed as a molded-on frame which is formed in that the partial filter elements are placed into a mold and subsequently surrounded by injection molding with an injection-molded frame wherein the material upon curing bonds non-detachably to the partial filter elements.

As a further alternative, the frame can be formed by a potting compound of polyurethane (PUR) or another pourable polymer, in particular of a foamed polyurethane, i.e., polyurethane foam.

A preferred embodiment of the invention provides that the second area of the filter element frame is designed so as to project into an intake air channel arranged downstream. In this way, constructive space for the filter volume can be gained without the function being impaired or the filter volume being reduced.

A particularly preferred embodiment provides that the two effective cross-sectional areas with regard to their length extension are different. A length extension of the second effective cross-sectional area is reduced by at least the wall thickness of an air channel element compared to the corresponding length extension of the first effective cross-sectional area.

One embodiment of the invention provides that the filter element frame at the transition from the first area to the second area is of a stepped configuration. The step can serve, for example, as an outer contact surface upon installation of the cabin air filter element. At the same time, the step in the inner area of the cabin air filter element can serve as a constructive separation of two filter layers.

In this context, in an advantageous way it can be provided that the gasket is arranged at an edge in the outer area of the step. In one embodiment, it is outside of the effective cross-sectional area of the first area. Accordingly, the step, in addition to the aforementioned stop and separation functions, can also receive integrally the gasket without the flowed-through volume in the first area of the filter housing being negatively affected.

In an alternative embodiment, the gasket in the area of the step is arranged within the effective cross-sectional area of the first area. Accordingly, either on the cabin air filter element or at the housing, a sealing surface can be provided without additional lateral space being required. This embodiment enables in particular in case of tight spatial conditions a particularly space-saving outer contour configuration. The gasket can be embodied either axially (i.e., here in or opposite to the flow direction) or radially (i.e., perpendicular to the flow direction), i.e., the sealing surface of the gasket is designed for contacting a counter sealing surface at the housing in axial or radial direction. The gasket can be arranged moreover externally on the filter element frame at various positions. An arrangement on the end of the first area which is facing away from the second area enables a housing wall to be snuggly positioned in flow direction along the filter element and thus provides spatial advantages. This applies also for gaskets arranged within the cross-section of the first area which are arranged in the area of the step or of the cross-sectional step, of the lateral outer wall of the second area, or circumferentially in axial direction about the end face of the second area.

In one embodiment, the gasket is formed by a circumferential gasket profile of a polymer, in particular of a foamed-on, in particular closed-pore, foam, for example, of polyurethane foam. When the frame is also formed of such a material, the gasket can be designed as a single piece together with the frame. Preferably, the gasket has a hardness in the range between 5 and 45 Shore A, in particular preferred of 13+/−4 Shore A.

In a preferred embodiment, the gasket is compressible or clampable seal-tightly between two housing parts of a filter housing axially or radially.

An embodiment of the invention that is also advantageous provides that, in the inner area of the step, either a common adhesive point for fixation of the filter layers arranged in the inner area of the cabin air filter element of the first and second area or, alternatively, two separate adhesive points that are closely adjacently positioned are provided. In this way, in one or in two working steps immediately following each other, after insertion of the filter layers, the appropriate adhesive points in the second area can be provided with adhesive in order to subsequently introduce the filter layers of the first area and to fasten them.

An embodiment of the invention which is also advantageous provides that the prefilter layer, the adsorption filter layer, and the fine filter layer each are sealingly and preferably firmly connected to the filter element frame. Preferably, the connection is such that the filter layers and the filter element frame cannot be separated in a non-destructive manner. This has the advantage that the cabin air filter element can be replaced as a one-piece part. Also, the three filter stages are reliably sealed in order to allow for use of the cabin air filter element in environments with a high amount of hazardous substances in the air stream. In preferred embodiments, the filter layers are connected to the filter element frame by welding or gluing.

The filter housing according to one embodiment can be embodied as a single part, in particular as an injection-molded part.

### BRIEF DESCRIPTION OF THE DRAWINGS

The invention will be explained with reference to the drawings in more detail.

FIG. 1 shows a first embodiment according to the invention of a cabin air filter element in perspective view from above in disassembled state.

FIG. 2 shows the first embodiment of the invention according to FIG. 1 in perspective view from below.

FIG. 3 shows the first embodiment of the FIGS. 1 and 2 as section view from above in the assembled state.

FIG. 4 shows a second embodiment as an alternative to the embodiment of FIG. 3.

FIG. 5 shows a third embodiment as an alternative to the embodiment of FIG. 4.

FIG. 6 shows the first embodiment of FIGS. 1 and 2 as section illustration from below in the assembled state.

FIG. 7 is a plan view of the first embodiment.

FIG. 8 is a side view of the first embodiment.

FIG. 9 is a perspective view of the first embodiment.

FIG. 10 shows a section view along the lines A-A of FIG. 7.

FIG. 11 is an enlarged detail of the section view of FIG. 10.

FIG. 12 shows a first variant of the gasket arrangement for the cabin air filter element.

FIG. 13 shows a second variant of the gasket arrangement for the cabin air filter element.

FIG. 14 shows a third variant of the gasket arrangement for the cabin air filter element.

FIG. 15 shows a fourth variant of the gasket arrangement for the cabin air filter element.

FIG. 16 shows a fifth variant of the gasket arrangement for the cabin air filter element.

### DESCRIPTION OF PREFERRED EMBODIMENTS

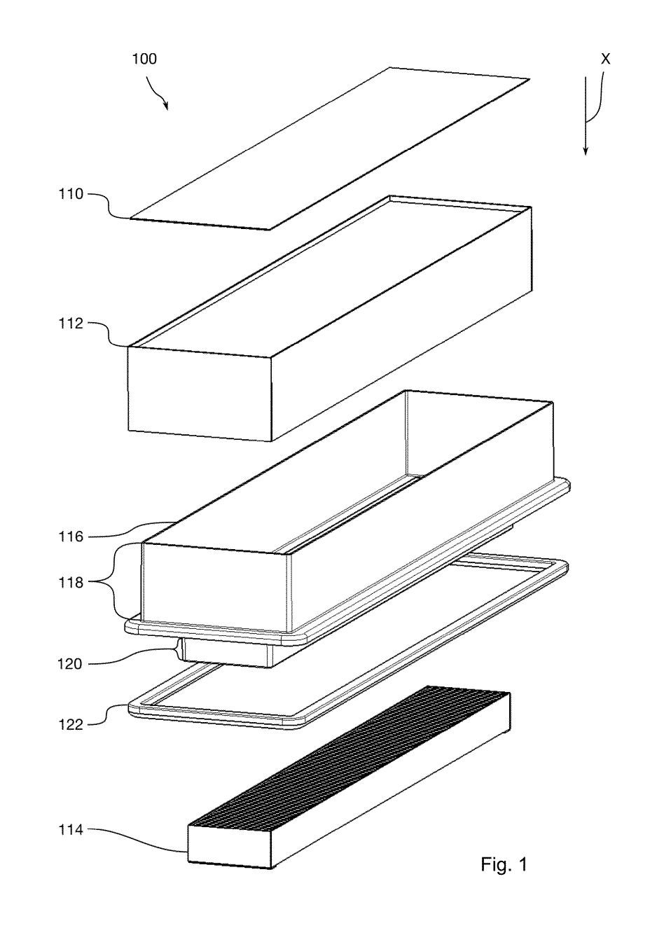

In FIG. 1 a cabin air filter element 100 according to the present invention is shown in disassembled state in a perspective view from above. The cabin air filter element 100 has a filter element frame 116. The filter element frame 116 is flowed through along the axis X. The filter element frame 116 can be divided into a first area 118 and a second area 120 which preferably have in the flow direction a different cross-section. In the first area 118 there is a particle filter 110 and an activated carbon bellows 112. In the second area 120 a HEPA bellows 114 is arranged. The cross-sectional step between the first area 118 and the second area 120 can be seen from the exterior. In the illustrated embodiment, in the area of the cross-section a circumferential gasket 122 is arranged.

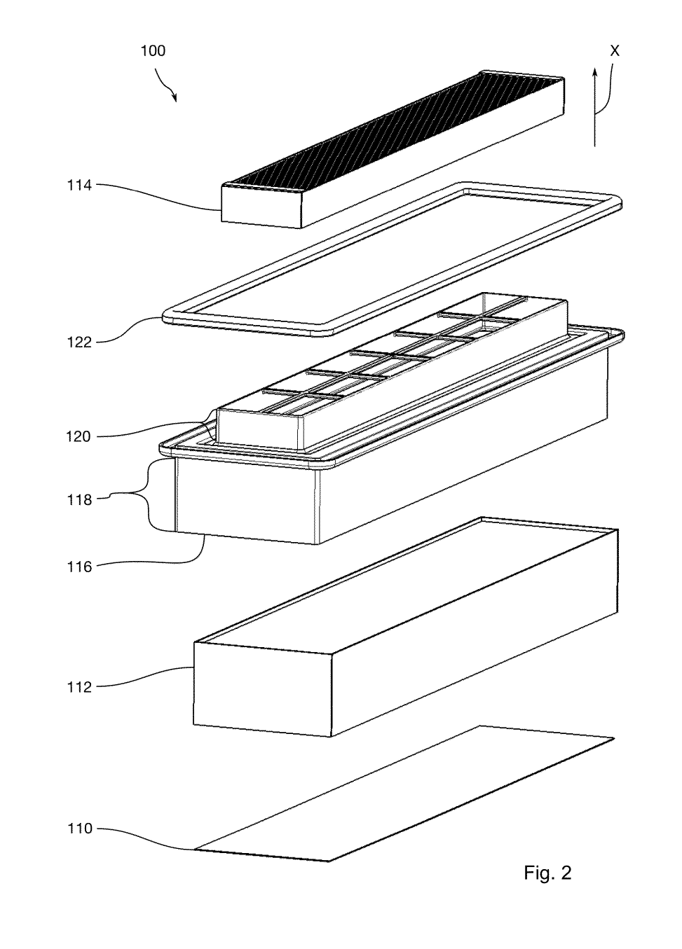

FIG. 2 shows the same embodiment of the cabin air filter element 100 in a perspective view from below.

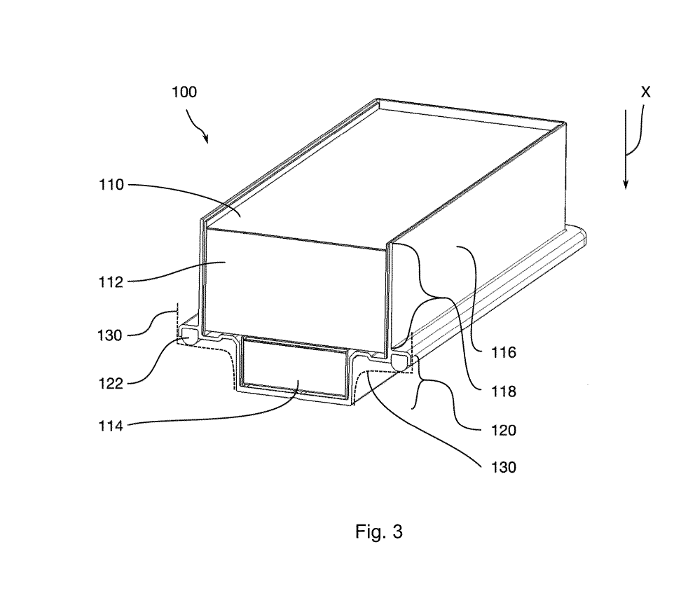

In FIG. 3, the cabin air filter element 100 is shown in the assembled state in a section view which is extending parallel to the axis X centrally through the cabin air filter element 100. As can be seen in this view, the HEPA bellows 114 is received in the second area 120 and the particle filter 110 together with the activated carbon bellows 112 are received in the first area 118. Also schematically indicated and shown in dashed line is an air channel 130 into which the second area 120 of the filter element frame 116 is projecting.

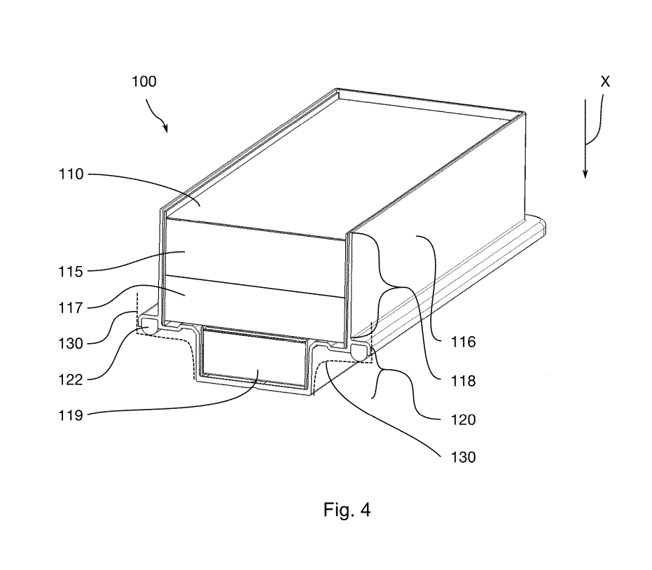

In FIG. 4, a second alternative embodiment is illustrated in which another division of the filter layers has been realized. The HEPA bellows as a HEPA bellows 115 is now arranged directly downstream of the particle filter 110. The activated carbon bellows is divided into a first activated carbon bellows 117 and a second activated carbon bellows 119.

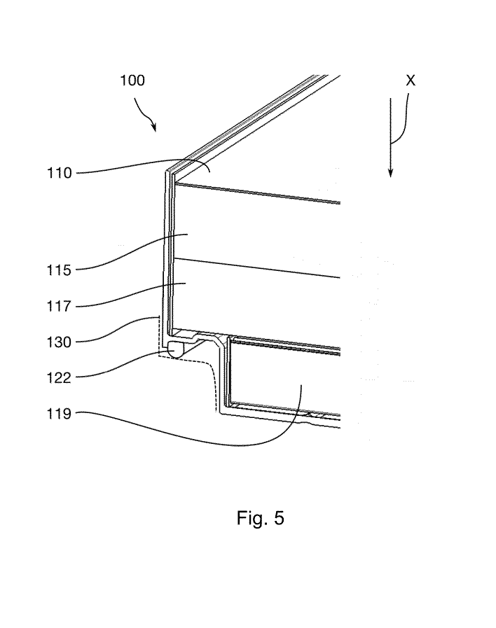

FIG. 5 shows a third alternative embodiment in which the gasket 122 assumes an alternative position. The gasket is located, viewed in flow direction X, below the step within the effective cross-sectional area of the first area 118.

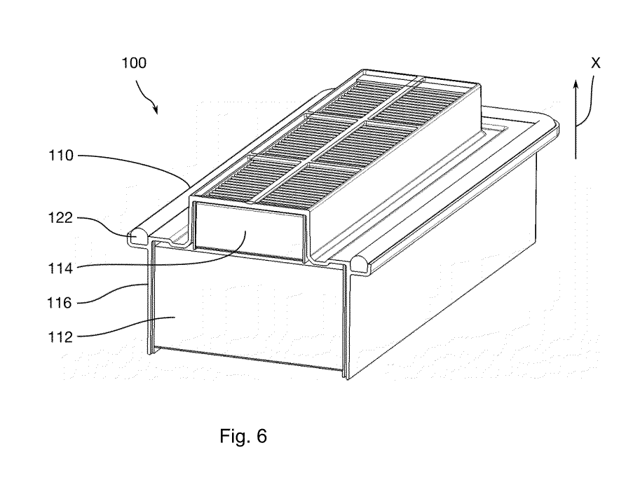

FIG. 6 shows the first embodiment of FIG. 2 in the assembled state.

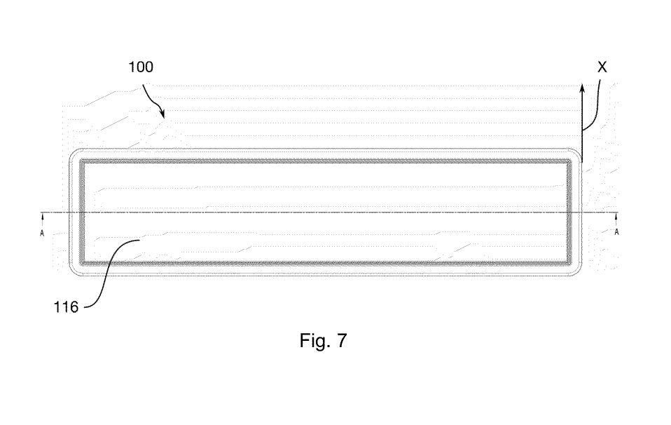

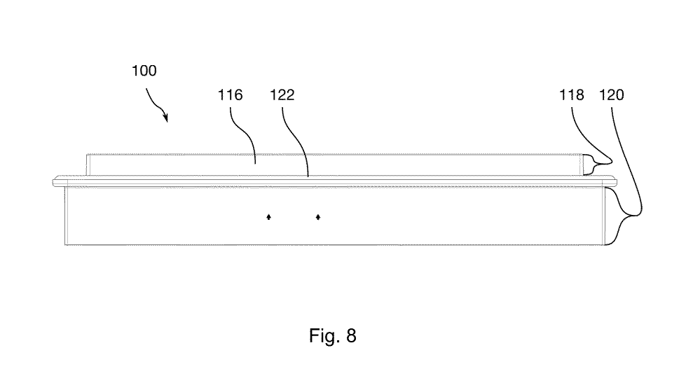

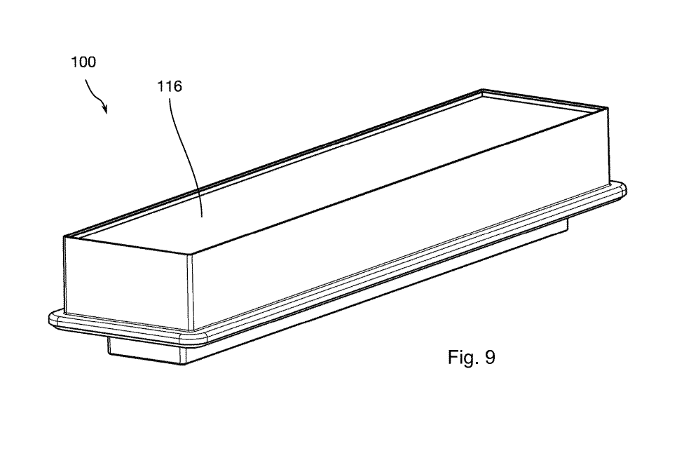

In FIGS. 7-9 a plan view, a side view, as well as an isometric perspective view of the cabin air filter element 100 are illustrated.

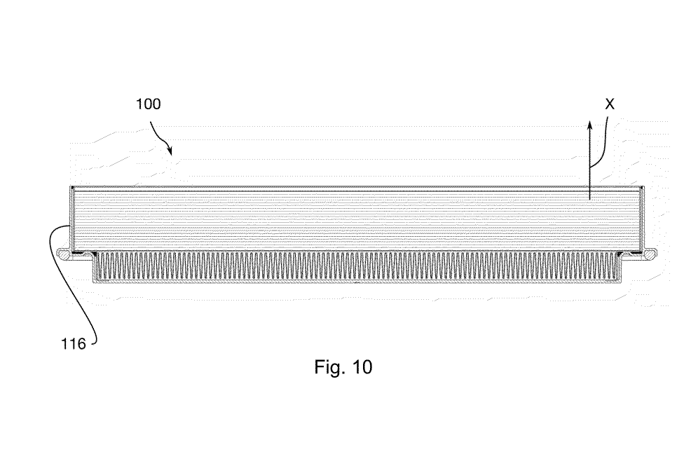

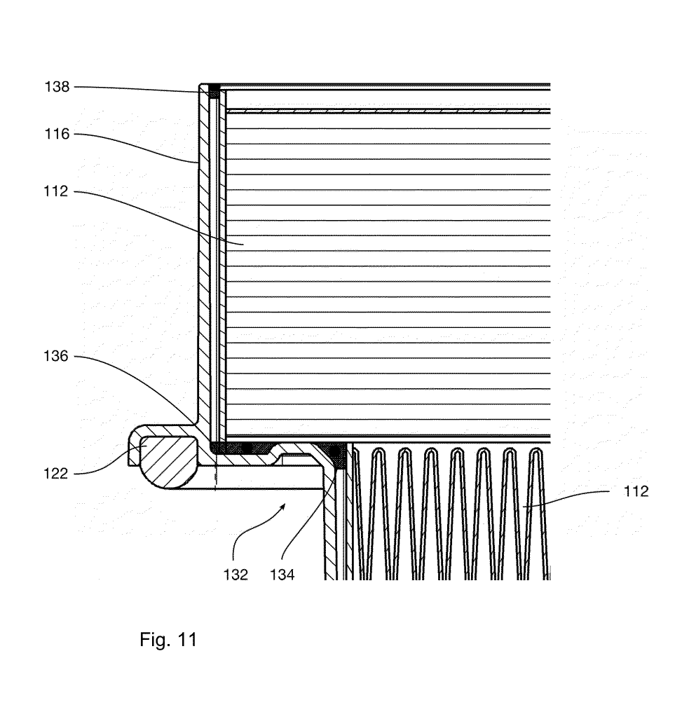

In FIG. 7 a section line A-A is shown. FIG. 10 shows the corresponding section along section line A-A. FIG. 11 an enlarged detail of the section view. In the illustration of FIG. 11 adhesive points can be seen. The HEPA bellows 114 is attached at the step 132 by means of an adhesive point 134. More precisely, the HEPA bellows 114 is fastened on the side of the step 132 which is facing the interior of the cabin air filter element 100 by means of an adhesive point. A second adhesive point 136 fastens the activated carbon bellows 112. The second adhesive point 136 is also arranged in the interior of the cabin air filter element 100, namely in the area of the step 132 which is closest to the exterior area. The adhesive points 134 and 136, as illustrated, can be designed so as to neighbor each other. Alternatively, the adhesive points 134 and 136 can also be provided as a single adhesive point. A further adhesive point 138 can optionally be provided. It fastens the prefilter 110. Should this adhesive point 138 be omitted, the prefilter 110 must be connected with the activated carbon bellows 112 prior to installation.

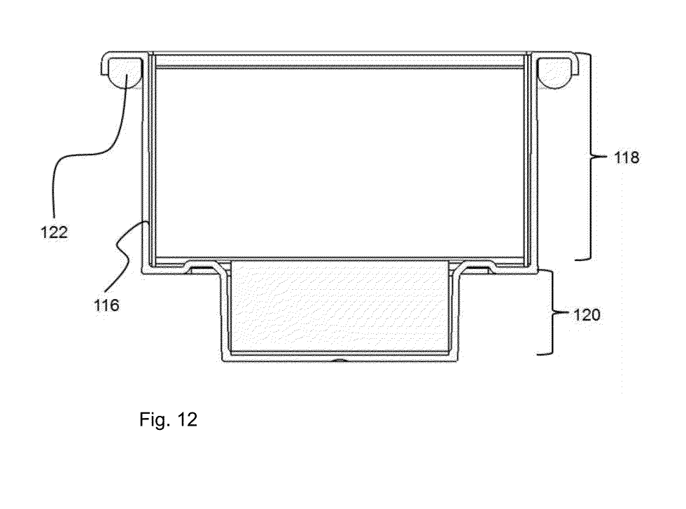

FIG. 12 shows a variant of an arrangement of the circumferentially extending gasket 122 which here is arranged externally on the wall of the first area 118 at its end which is facing away from the second area 120 and is acting axially in the direction of the second area 120.

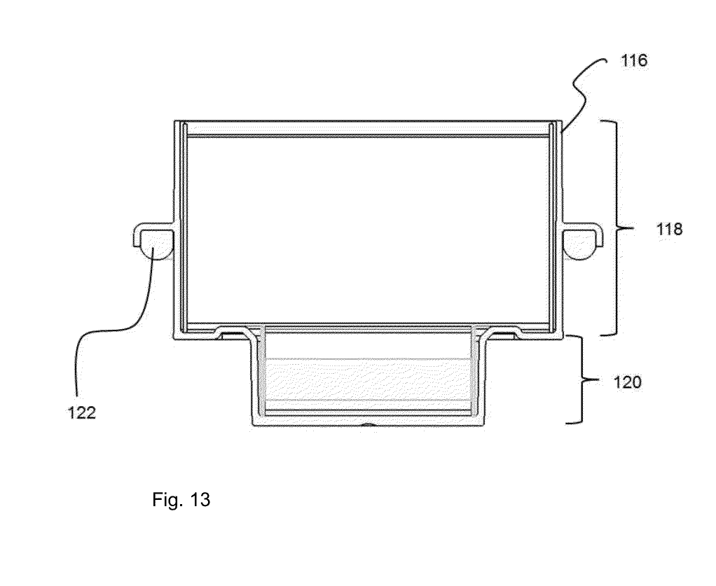

FIG. 13 shows a variant of an arrangement of the circumferentially extending gasket 122 which here is externally and centrally arranged at the wall of the first area 118 and is acting axially in the direction of the second area 120.

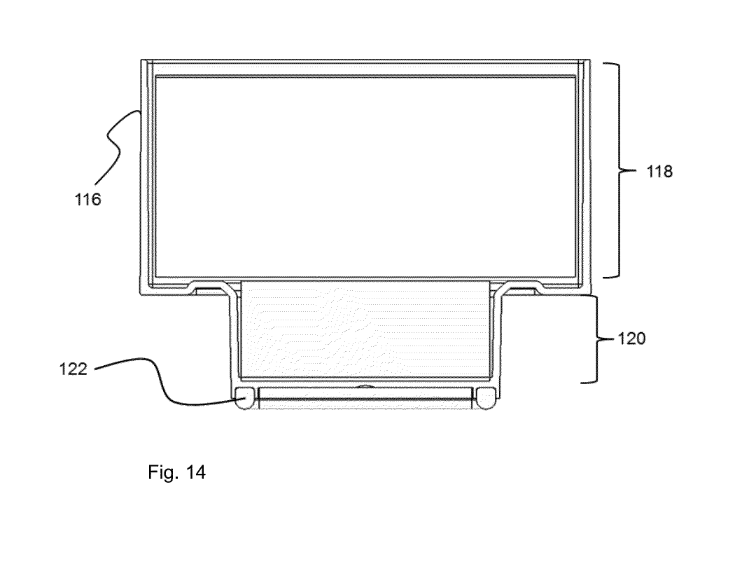

FIG. 14 shows a variant of an arrangement of the circumferentially extending gasket 122 which here is axially arranged at the end of the second area 120 which is facing away from the first area 118 and circumferentially about the flow end face of the second area 120.

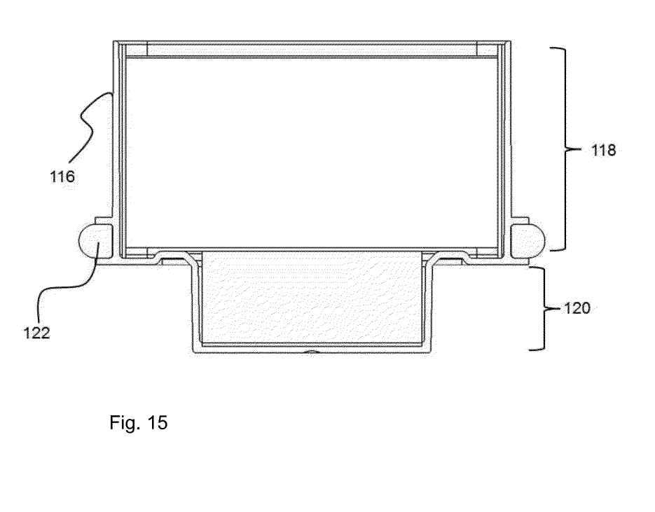

FIG. 15 shows a variant of an arrangement of the circumferentially extending gasket 122 which here is arranged at the wall of the first area 118 at its end that is facing the second area 120 and is acting radially.

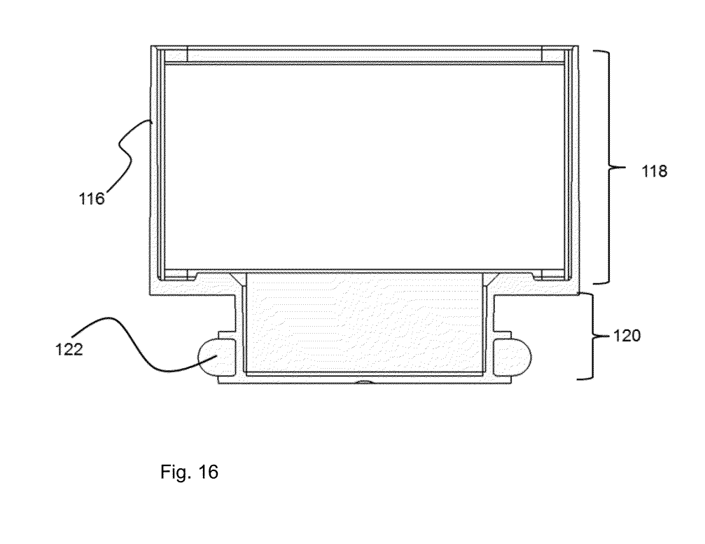

FIG. 16 shows a variant of an arrangement of the circumferentially extending gasket 122 which here is arranged externally on the wall of the second area 120 at its end which is facing away from the first area 118 and is acting radially.

In regard to embodiment details of the filter media configuration, reference is being made moreover to U.S. patent application Ser. No. 13/939,678 of the applicant, the full disclosure of which can be applied analogously to the present application. U.S. patent application Ser. No. 13/939,678 filed Jul. 11, 2013 is hereby incorporated by reference in its entirety and to the fullest extent permitted by the law. U.S. patent application Ser. No. 13/939,678 is a non-provisional of U.S. provisional application 61/733,550 filed Dec. 5, 2012.

While specific embodiments of the invention have been shown and described in detail to illustrate the inventive principles, it will be understood that the invention may be embodied otherwise without departing from such principles.

What is claimed is:

1. A cabin air filter element for a cabin air filter for the driver's cabin of agricultural and work machines, the cabin air filter element comprising:
a filter element frame;
filter layers arranged in the filter element frame and flowed through in a flow direction, wherein the filter layers include a prefilter layer, an adsorption filter layer, and a fine filter layer;
a circumferentially extending gasket arranged on the filter element frame for separation of the raw side from the clean side in a mounted state of the cabin air filter element;
wherein the filter element frame comprises a first area and a second area, wherein the first area comprises a first effective cross-sectional area perpendicular to the flow direction and wherein the second area comprises a second effective cross-sectional area perpendicular to the flow direction, wherein the second effective cross-sectional area has a size that amounts to only a portion of a size of the first effective cross-sectional area.

2. The cabin air filter element according to claim 1, wherein the first area is arranged geometrically upstream of the gasket and the second area is arranged geometrically downstream of the gasket.

3. The cabin air filter element according to claim 1, wherein the prefilter layer and the adsorption filter layer are arranged in the first area and the fine filter layer is arranged in the second area.

4. The cabin air filter element according to claim 1, wherein the adsorption filter layer comprises a first partial filter layer and a second partial filter layer, wherein the prefilter layer, the fine filter layer, and the first partial filter layer of the adsorption filter layer are arranged in the first area and wherein the second partial filter layer of the adsorption filter layer is arranged in the second area.

5. The cabin air filter element according to claim 1, wherein the prefilter layer is a particle filter layer.

6. The cabin air filter element according to claim 1, wherein the adsorption filter layer is an activated carbon layer.

7. The cabin air filter element according to claim 1, wherein the fine filter layer is a HEPA filter layer.

8. The cabin air filter element according to claim 1, wherein the second area of the filter element frame is configured to project in the mounted state into an intake air channel arranged downstream of the cabin air filter element.

9. The cabin air filter element according to claim 8, wherein a first length extension of the second effective cross-sectional area in a first direction and a second length extension of the second effective cross-sectional area in a second direction perpendicular to the first direction are reduced by at least a wall thickness of an air channel element of the intake air channel compared to first and second length extensions of the first effective cross-sectional area in the first and second directions, respectively.

10. The cabin air filter element according to claim 1, wherein the filter element frame has a step at a transition from the first area into the second area.

11. The cabin air filter element according to claim 10, wherein the gasket is arranged at an edge in an outer area of the step.

12. The cabin air filter element according to claim 11, wherein the gasket is arranged outside of the effective cross-sectional area of the first area.

13. The cabin air filter element according to claim 10, wherein the gasket is arranged in the area of the step within the effective cross-sectional area of the first area.

14. The cabin air filter element according to claim 10, wherein the step comprises an inner area and wherein in the inner area of the step a common adhesive point for fixation of the filter layers arranged in the first area and the second area is provided.

15. The cabin air filter element according to claim 10, wherein the step comprises an inner area and wherein in the inner area of the step two separate adhesive points for fixation of the filter layers arranged in the first area and the second area are provided, wherein the two separate adhesive points are adjoining each other.

16. The cabin air filter element according to claim 1, wherein the filter element frame is a single part.

17. The cabin air filter element according to claim 16, wherein the filter element frame is an injection-molded part.

18. The cabin air filter element according to claim 16, wherein the prefilter layer, the adsorption filter layer, and the fine filter layer are sealingly connected to the filter element frame.

19. A system for cabin air filtration of a driver's cabin of agricultural and work machines, comprising a cabin air filter housing and a cabin air filter element according to claim 1, configured to be mounted in the cabin air filter housing.
